(19) United States
(12) Patent Application Publication
(10) Pub. No.: US 2012/0194603 A1
(43) Pub. Date: Aug. 2, 2012

(54) RECORDING APPARATUS

(75) Inventors: Kengo TAKEDA, Inazawa-shi (JP); Shigeki KATO, Toyoake-shi (JP)

(73) Assignee: BROTHER KOGYO KABUSHIKI KAISHA, Nagoya-shi (JP)

(21) Appl. No.: 13/351,528

(22) Filed: Jan. 17, 2012

(30) Foreign Application Priority Data
Jan. 31, 2011 (JP) 2011-018195

(51) Int. Cl. B41J 2/165

(52) U.S. Cl. 347/22

(57) ABSTRACT

A recording apparatus, including: an endless belt having first and second areas each defined by two rollers and looped over rollers including at least one tension roller and at least one drive roller; a recording head opposed to the first area; and a first cleaning member, wherein, in a cleaning mode in which the first cleaning member cleans the belt, a controller is configured to have the first cleaning member be held in contact with the second area and to drive at least one of the at least one drive roller such that the second area is located on a downstream side of the at least one tension roller and on an upstream side of the at least one of the at least one drive roller in a running direction of the belt.

### CROSS REFERENCE TO RELATED APPLICATION

The present application claims priority from Japanese Patent Application No. 2011-018195, which was filed on Jan. 31, 2011, the disclosure of which is herein incorporated by reference in its entirety.

### BACKGROUND OF THE INVENTION

1. Field of the Invention

The present invention relates to a recording apparatus configured to record an image on a recording medium.

2. Description of the Related Art

There is known a recording apparatus including a rotatable endless belt looped over a drive roller, a tension roller, and a driven roller. In this recording apparatus, the recording head is disposed so as to be opposed to a first area (on the belt) defined by the drive roller and the driven roller. A cleaning member for cleaning a face of the belt is disposed so as to contact a second area (on the belt) defined by the drive roller and the tension roller. When the drive roller is rotated, the belt runs or is rotated such that the first area is moved to a position located on a downstream side of the tension roller and on an upstream side of the drive roller in a running direction of the belt and such that the second area is moved to a position located on a downstream side of the drive roller and located on an upstream side of the tension roller in the running direction of the belt.

### SUMMARY OF THE INVENTION

In this recording apparatus, the second area to be contacted by the cleaning member is located on a downstream side of the drive roller and located on an upstream side of the tension roller in the running direction of the belt. Here, the cleaning member gives a resistance to the running belt. Thus, the belt rotated by the drive roller is given the resistance by the cleaning member, so that slack occurs at a portion of the belt between the drive roller and the cleaning member. As a result, the belt and the drive roller may be partially disengaged from each other, causing a slip of the belt relative to the drive roller. This slip of the belt lowers a running accuracy of the belt, causing unstable contact between the cleaning member and the belt. Thus, a cleaning performance in the cleaning of the belt by the cleaning member may be lowered.

Meanwhile, if the cleaning member contacts the first area, a certain portion of the belt rotated by the drive roller passes through the tension roller to reach the cleaning member. Thus, even when the slack is about to occur at the portion of the belt between the drive roller and the cleaning member by the resistance of the cleaning member, the tension roller applies a tension to the belt. This makes it difficult for the belt to be slack, causing less slip of the belt. Thus, if the cleaning member is disposed at the first area, it is possible to prevent the lowering of the cleaning performance in the cleaning of the belt by the cleaning member.

However, in this recording apparatus, the recording head is disposed at a position opposed to the first area located on a downstream side of the tension roller and located on an upstream side of the drive roller in the recording. Thus, there is not enough space for the placement of the cleaning member in the area located on a downstream side of the tension roller and located on an upstream side of the drive roller in the recording. If the cleaning member is additionally placed at a position at which the cleaning member can contact the first area, a size of the recording apparatus is made larger. Since the first area is an area in which the slack is less likely to occur, the recording head is preferably disposed so as to be opposed to the first area in order to prevent an image quality from lowering.

This invention has been developed in view of the above-described situations, and it is an object of the present invention to provide a recording apparatus capable of preventing the apparatus from increasing in size and preventing a slip between a drive roller and a belt when the belt is cleaned.

The object indicated above may be achieved according to the present invention which provides a recording apparatus, comprising: a conveyance mechanism including an endless belt looped over a plurality of rollers that are arranged so as to be distant from one another and that include at least one tension roller and at least one drive roller, the endless belt having a face including (i) a first area defined by two rollers of the plurality of rollers and (ii) a second area defined by two rollers of the plurality of rollers and not overlapping with the first area, the conveyance mechanism being configured to convey a recording medium supported on the first area; a recording head opposed to the first area and configured to eject liquid onto the recording medium supported on the first area to record an image; a cleaning mechanism including a first cleaning member contactable with the second area to selectively take a contact state in which the first cleaning member is held in contact with the second area and a distant state in which the first cleaning member is distant from the second area; and a controller configured to control the conveyance mechanism and the cleaning mechanism, wherein, in a recording mode in which the recording head records the image, the controller is configured to drive at least one of the at least one drive roller such that the first area is located on a downstream side of the at least one tension roller and located on an upstream side of the at least one of the at least one drive roller in a running direction of the belt and such that the second area is located on a downstream side of the at least one of the at least one drive roller and located on an upstream side of the at least one tension roller in the running direction of the belt, and wherein, in a cleaning mode which does not overlap with the recording mode timewise and in which the first cleaning member cleans the belt, the controller is configured to have the first cleaning member be in the contact state and to drive at least one of the at least one drive roller such that the second area is located on a downstream side of the at least one tension roller and located on an upstream side of the at least one of the at least one drive roller in the running direction of the belt.

### BRIEF DESCRIPTION OF THE DRAWINGS

The objects, features, advantages, and technical and industrial significance of the present invention will be better understood by reading the following detailed description of embodiments of the invention, when considered in connection with the accompanying drawings, in which:

FIG. 1 is a side view generally showing an overall construction of an ink-jet printer as a first embodiment of the present invention;

FIG. 2 is a plan view generally showing a conveyance mechanism shown in FIG. 1

FIG. 3 is a perspective view generally showing a maintenance unit shown in FIG. 1;

FIG. 4A is a side view generally showing the conveyance mechanism and the maintenance unit, FIG. 4B is a partial enlarged view showing the maintenance unit;

FIG. 5 is a block diagram showing an electric configuration of the printer;

FIG. 6 is a flow-chart showing a recording mode and a cleaning mode executed by a controller of the printer;

FIG. 7A is a side view generally showing a conveyance mechanism and a maintenance unit of an ink-jet printer as a second embodiment of the present invention, and FIG. 7B is a partial enlarged view showing the maintenance unit; and

FIG. 8 is a side view generally showing a conveyance mechanism and a maintenance unit of an ink-jet printer as a third embodiment of the present invention.

### DETAILED DESCRIPTION OF THE EMBODIMENTS

Hereinafter, there will be described embodiments of the present invention by reference to the drawings.

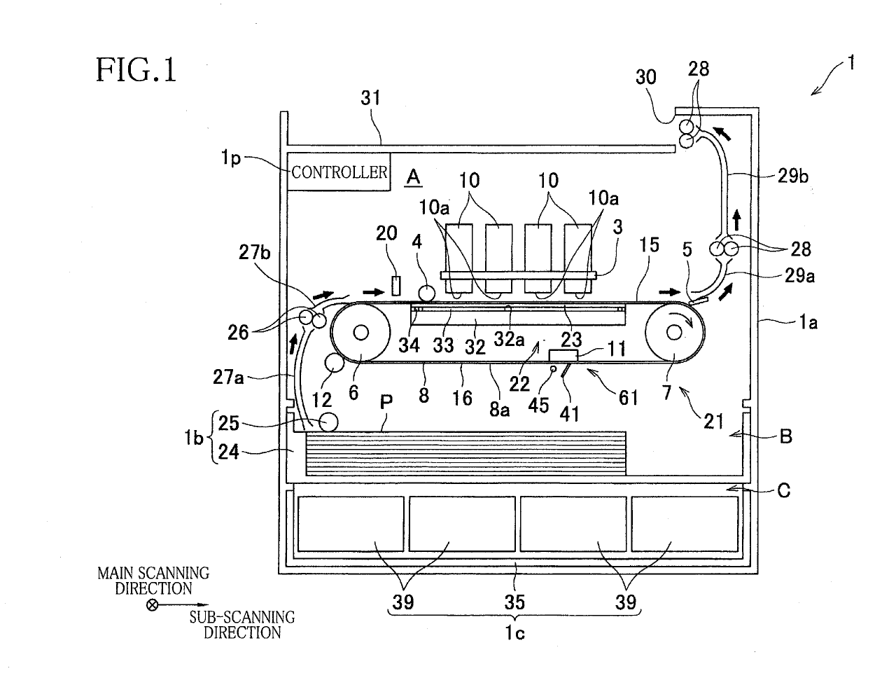

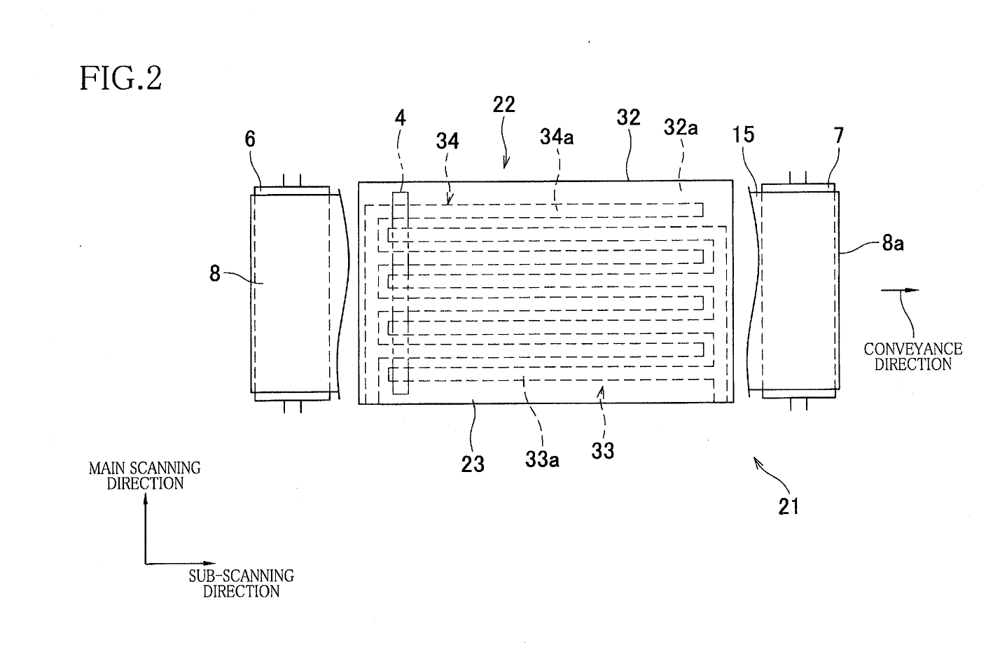

First, there will be explained an overall construction of an ink-jet printer 1 as a first embodiment of a recording apparatus to which the present invention is applied, with reference to FIGS. 1 and 2.

The printer 1 includes a casing 1a having a rectangular parallelepiped shape. A sheet-discharge portion 31 is provided at an upper portion of a top plate of the casing 1a. An inner space of the casing 1a is divided into spaces A, B, and C in order from an upper side thereof. In the spaces A, B is formed a sheet conveyance path which is continuous to the sheet-discharge portion 31. In the space C, four cartridges 39 are accommodated. Each of the four cartridges 39 can store an ink to be supplied to a corresponding one of four ink-jet heads 10, that is, each cartridge 39 functions as an ink supply source for the corresponding ink-jet head 10.

In the space A, there are arranged the four heads 10, a conveyance mechanism 21, a maintenance unit 61, a guide unit, and so on. The four heads 10 respectively eject the inks of respective four colors, namely, magenta, cyan, yellow, and black. The conveyance mechanism 21 conveys or feeds a recording medium such as a sheet P in a conveyance direction (a direction from a left side toward a right side in FIG. 1). The guide unit is for guiding the sheet P. In the space A, there is disposed a controller 1p configured to control operations of components of the printer 1 to control an overall operation of the printer 1.

Here, in the present embodiment, the printer 1 is in a recording mode during a period extending from a point in time when the printer 1 has received a recording command supplied from an external device (e.g., a recording signal containing image data and the like), to a point in time when a recording operation based on the recording command is completed (noted that the recording operation includes a conveyance operation of the sheet P and an ink ejecting operation synchronized with the conveyance operation, for example). In the recording mode, the controller 1p controls the components of the printer 1 to perform the conveyance operation of the sheet P, the ink ejecting operation synchronized with the conveyance operation, and so on. It is noted that, in the present embodiment, a second wiping operation (which will be described below) for cleaning a face 8a of a conveyance belt 8 is performed in the recording mode. That is, in the recording mode, the recording operation is performed while the cleaning of the face 8a of the conveyance belt 8 is performed. Further, during a period from a receipt of a wiping command by the printer 1 to a completion of a wiping operation based on the wiping command, the printer 1 is in a cleaning mode. It is noted that, in the present embodiment, a first wiping operation (which will be described below) for cleaning the face 8a of the conveyance belt 8 is performed in the cleaning mode. It is noted that the recording operation is not performed in the cleaning mode. It is noted that, in this first embodiment, and a second and a third embodiment which will be described below, the recording mode does not coincide with the cleaning mode timewise, that is, the printer 1 is never in both of the recording mode and the cleaning mode at the same time.

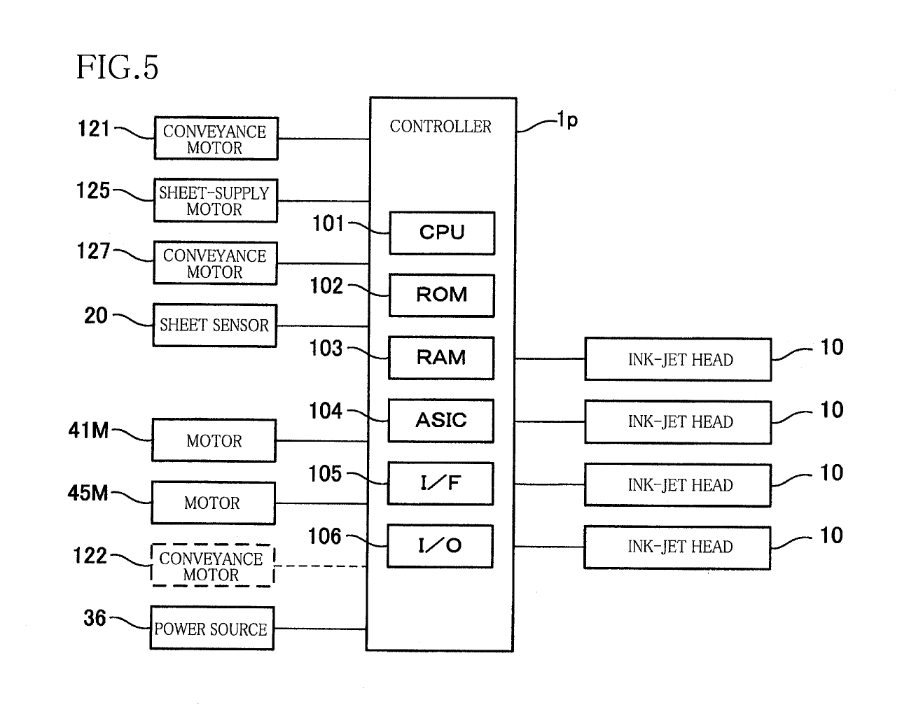

The conveyance mechanism 21 includes: (a) two belt rollers 6, 7 arranged so as to be distant from each other in a sub-scanning direction; (b) the endless conveyance belt 8 looped over or wound around the rollers 6, 7; (c) a nip roller 4 and a peeling plate 5 disposed outside the conveyance belt 8; (d) an adsorptive (attractive) platen 22 disposed inside the conveyance belt 8; and so on. Further, the conveyance mechanism 21 includes a conveyance motor 121 (see FIG. 5) and a plurality of gears, not shown, used for transmitting a rotational power of the conveyance motor 121 to the belt roller 7. Here, the sub-scanning direction is a direction parallel to the conveyance direction in which the sheet P is conveyed by the conveyance mechanism 21, and a main scanning direction is a direction parallel to a horizontal plane and perpendicular to the sub-scanning direction.

The belt roller 7 is a drive roller that is rotated by the conveyance motor 121 controlled by the controller 1p to rotate or run the conveyance belt 8. The belt roller 7 can be rotated forwardly and reversely. When rotated in its forward direction, the belt roller 7 is rotated in a clockwise direction in FIG. 1. In the recording mode, the belt roller 7 is rotated in the forward direction (as one example of one direction), and in the cleaning mode, the belt roller 7 is rotated in the reverse direction (as one example of a direction opposite to the one direction). When the belt roller 7 is rotated, the conveyance belt 8 runs in a direction that is the same as the direction in which the belt roller 7 is rotated.

The belt roller 6 is a tension roller that is rotated in accordance with the running or rotation of the conveyance belt 8 while applying a tension to the conveyance belt 8. The belt roller 6 is urged by an urging mechanism, not shown, in a direction parallel to the sub-scanning direction and away from the belt roller 7. As a result, the tension is applied to the conveyance belt 8.

The conveyance belt 8 is formed of, e.g., polyimide and a fluorocarbon resin and has a volume resistivity of about between 10⁸ and 10¹⁴ Ωcm (ohm-cm), and has a flexibility. However, any material may be used for the conveyance belt 8 as long as the conveyance belt 8 has a volume resistivity and a flexibility similar to the above.

As shown in FIGS. 1 and 2, the adsorptive platen 22 includes: a plate-like base member (material) 32 formed of an insulating material; two electrodes 33, 34 bonded on an upper face 32a of the base member 32; a protective film 23 bonded on the upper face 32a so as to cover an entire area of the electrodes 33, 34. The adsorptive platen 22 is disposed so as to face the heads 10, with the conveyance belt 8 interposed therebetween. The adsorptive platen 22 supports a first area 15 on the conveyance belt 8 from an inside thereof.

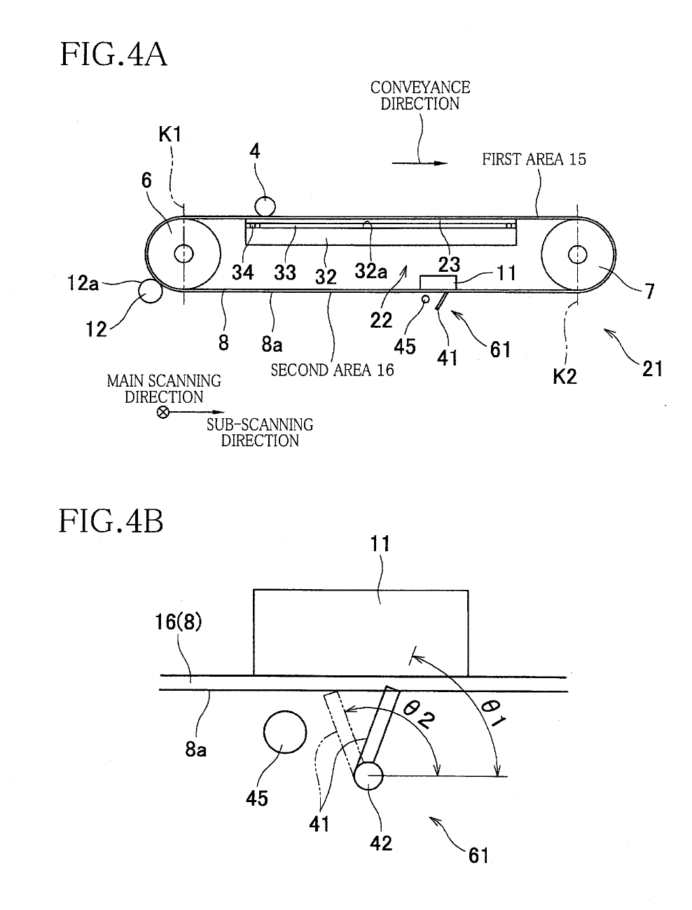

The first area 15 of the conveyance belt 8 is an upper one of two areas (the first area 15 and a second area 16) each defined by the two belt rollers 6, 7. These two areas 15, 16 are located on the conveyance belt 8 between imaginary straight lines K1, K2 (see FIG. 4A) extending in a vertical direction so as to pass through centers of the respective belt rollers 6, 7, and these two areas 15, 16 are arranged so as to be parallel to each other. In other words, assuming that an area of the conveyance belt 8 which contacts any of the belt rollers 6, 7 is a contact area, that an area of the conveyance belt 8 which does not contact any of the belt rollers 6, 7 is a non-contact area, and that a boundary on the conveyance belt 8 between the contact area and the non-contact area is a contact boundary (in the present embodiment, areas of the conveyance belt 8 each of which intersects a corresponding one of the imaginary straight lines K1, K2 in FIG. 4A corresponds to the contact boundary), each of the two areas 15, 16 is a non-contact area on the conveyance belt 8 which is located between the contact boundaries of the respective belt rollers 6, 7 and which does not include any contact area. The first area 15 is an upper one of the two non-contact areas, and the second area 16 is a lower one of the two non-contact areas. Further, the first area 15 is located on the conveyance belt 8 at an area thereon located nearer to the heads 10 than the second area 16, and the face 8a of the first area 15 faces ejection faces 10a of the respective heads 10. Further, the face 8a of the first area 15 is a face for supporting the sheet P and is opposed to the ejection faces 10a so as to be parallel to each other. The first area 15 is located on a downstream side of the belt roller 6 (the tension roller) and on an upstream side of the belt roller 7 (the drive roller) in a running direction (forward running direction) in which the conveyance belt 8 runs by the forward rotation of the belt roller 7 (specifically, in the running direction in which an upper loop portion of the conveyance belt 8 on which the first area 15 is located runs by the forward rotation of the belt roller 7). Further, the second area 16 is located on a downstream side of the belt roller 7 and located on an upstream side of the belt roller 6 in the running direction in which the conveyance belt 8 runs by the forward rotation of the belt roller 7 (specifically, in the running direction in which a lower loop portion of the conveyance belt 8 on which the second area 16 is located runs by the forward rotation of the belt roller 7). On the other hand, the second area 16 is located on a downstream side of the belt roller 6 and located on an upstream side of the belt roller 7 in a running direction (reverse running direction) in which the conveyance belt 8 runs by the reverse rotation of the belt roller 7 (specifically, in the running direction in which the lower loop portion of the conveyance belt 8 on which the second area 16 is located runs by the reverse rotation of the belt roller 7).

It is noted that, in the present embodiment, an entire area of the upper non-contact area of the conveyance belt 8 is the first area 15, and an entire area of the lower non-contact area of the conveyance belt 8 is the second area 16, but a portion of the upper non-contact area of the conveyance belt 8 may be the first area 15, and a portion of the lower non-contact area of the conveyance belt 8 may be the second area 16. Further, the words “the first area 15 is located on a downstream side of the belt roller 6 and located on an upstream side of the belt roller 7 in the running direction of the conveyance belt 8” means that the belt roller 6 is the nearest positioned belt roller that is located at the nearest position to the first area 15 on a downstream side of the first area 15 in the running direction of the conveyance belt 8 among the rollers, and the belt roller 7 is the nearest positioned belt roller that is located at the nearest position to the first area 15 on an upstream side of the first area 15 in the running direction of the conveyance belt 8 among the rollers. Likewise, the words “the second area 16 is located on a downstream side of the belt roller 7 and located on an upstream side of the belt roller 6 in the running direction of the conveyance belt 8” means that the belt roller 7 is the nearest positioned belt roller that is located at the nearest position to the second area 16 on a downstream side of the second area 16 in the running direction of the conveyance belt 8 among the rollers, and the belt roller 6 is the nearest positioned belt roller that is located at the nearest position to the second area 16 on an upstream side of the second area 16 in the running direction of the conveyance belt 8 among the rollers.

The electrode 33 includes a plurality of elongated portions 33a extending in the sub-scanning direction. The electrode 34 includes a plurality of elongated portions 34a extending in the sub-scanning direction. Each of the electrodes 33, 34 has a comb-like shape such that these elongated portions 33a, 34a are alternately arranged one by one in the main scanning direction. Further, the electrodes 33, 34 are connected to a power source 36 (see FIG. 5) provided in the casing 1a. It is noted that the power source 36 is controlled by the controller 1p. The adsorptive platen 22 and the power source 36 constitute an adsorption portion for adsorbing or attracting the sheet P to the support face 8a of the first area 15.

The protective film 23 is formed of, e.g., polyimide and a fluorocarbon resin and has a volume resistivity of about between 10⁸ and 10¹⁴ Ωcm. However, any material may be used for the protective film 23 as long as the protective film 23 has a volume resistivity similar to the above.

The nip roller 4 is disposed on an upstream end of the adsorptive platen 22 at a position facing the elongated portions 33a, 34a of the respective electrodes 33, 34. The nip roller 4 presses the sheet P supplied from a sheet-supply unit 1b, onto the face 8a of the first area 15. This nip roller 4 is a roller formed of a material having conductivity.

In the recording mode, the belt roller 7 is forwardly rotated by the controller 1p, which causes the conveyance belt 8 to run such that a part of the conveyance belt 8 at the first area 15 is moved in the conveyance direction. The belt roller 6 and the nip roller 4 also run in accordance with the running of the conveyance belt 8. In these operations, different electric potentials are respectively applied to the electrodes 33, 34 by the control of the controller 1p. For example, a positive or a negative potential is applied to the electrode 33, and a ground potential is applied to the electrode 34. It is noted that, when the sheet P is conveyed by the conveyance belt 8, an electric potential of, e.g., 1 kV is applied to the electrode 33.

Since the nip roller 4 has conductivity, when the electric potentials have been applied to the two electrodes 33, 34, a current flows, at an area opposed to the nip roller 4, through the electrode 33 (the elongated portion 33a), the protective film 23, the conveyance belt 8, the sheet P, and the nip roller 4 in order and then flows through the nip roller 4, the sheet P, the conveyance belt 8, the protective film 23, and the electrode 34 (the elongated portion 34a) in order. Positive or negative electric charges are then produced at an area of the conveyance belt 8 which faces the sheet P, and electric charges whose polarity is different from that of the produced electric charges are induced at the face of the conveyance belt 8 which faces the sheet P. As a result, an adsorptive (attractive) force is produced which adsorbs or attracts the sheet P to the conveyance belt 8 by attraction of the electric charges to each other. It is noted that the current produced by an application of a voltage to the two electrodes 33, 34 also produces an adsorptive force which adsorbs the conveyance belt 8 to the adsorptive platen 22.

On the other hand, at an area not opposed to the nip roller 4, the current flows through the electrode 33 (the elongated portion 33a), the protective film 23, the conveyance belt 8, and the sheet P and then flows through the sheet P, the conveyance belt 8, the protective film 23, and the electrode 34 (the elongated portion 34a). Since a resistance value of the sheet P at this time is extremely larger than the nip roller 4, a resistance value of this entire path is larger than that of the path including the nip roller 4. Thus, even where the same electric potentials are applied to the electrodes 33, 34, a current value of the path including the nip roller 4 is larger. Further, a “Johnsen-Rahbeck force” exerted on an area between the conveyance belt 8 and the sheet P, i.e., the adsorptive force produced by the adsorptive platen 22 increases with an increase in a current flowing through the area. Accordingly, when the current value is made larger, the adsorptive force at the area opposed to the nip roller 4 becomes larger than that at the other area.

Thus, the sheet P supplied by the sheet-supply unit 1b is first adsorbed to the face 8a at the area at which the adsorptive force becomes considerably large (i.e., the area opposed to the nip roller 4). The sheet P is then conveyed in the conveyance direction while being adsorbed to the other area (the area not opposed to the nip roller 4). In this operation, when the sheet P conveyed while being adsorbed onto the face 8a of the first area 15 passes through positions just under the four ink-jet heads 10 (i.e., areas facing the ejection faces 10a) in order, the controller 1p controls the heads 10 to eject the inks of respective colors onto the sheet P. As a result, a desired color image is formed on the sheet P. The peeling plate 5 is disposed so as to face the belt roller 7 and configured to peel off the sheet P from the conveyance belt 8 to guide the sheet P toward a downstream side in the conveyance direction.

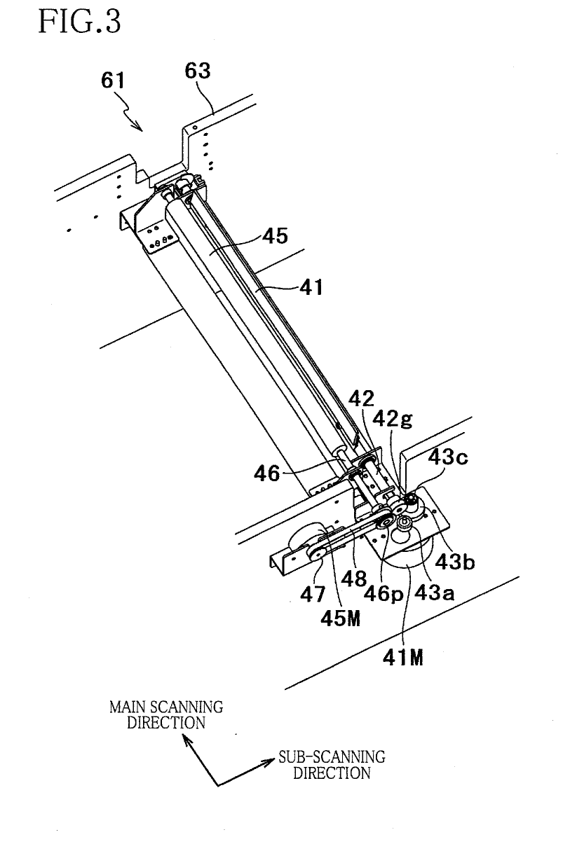

The maintenance unit 61 is disposed at a position near a lower end of the conveyance mechanism 21 and opposed to the second area 16 of the conveyance belt 8. A platen 11 for supporting the second area 16 from an inside of the conveyance belt 8 is disposed at a position inside the conveyance belt 8 and opposed to a wiper 41 with the conveyance belt 8 interposed between the platen 11 and the wiper 41. When the wiper 41 removes foreign matters, the platen 11 prevents the conveyance belt 8 from being deformed by a pressing force of the wiper 41, ensuring a high wiping performance. The construction of the maintenance unit 61 will be described below in more detail with reference to FIGS. 3, 4A, and 4B.

Each of the heads 10 is a line head having a generally rectangular parallelepiped shape elongated in the main scanning direction. Each head 10 has the lower face functioning as the ejection face 10a having a multiplicity of ejection openings formed therein. When the image recording (the image forming) is performed, each head 10 ejects the ink of the corresponding one of four colors, namely, black, magenta, cyan, and yellow, from the corresponding ejection face 10a. The heads 10 are supported by the casing 1a via a head holder 3 so as to be arranged at predetermined pitches in the sub-scanning direction. The head holder 3 holds the heads 10 such that the ejection faces 10a face the face 8a of the first area 15 so as to provide a specific space suitable for the recording between the face 8a and the ejection faces 10a.

The guide unit includes an upstream guide portion and a downstream guide portion arranged respectively on opposite sides of the conveyance mechanism 21. The upstream guide portion includes two guides 27a, 27b and a pair of conveyance rollers 26 and connects between the conveyance mechanism 21 and the sheet-supply unit 1b which will be described below. The downstream guide portion includes two guides 29a, 29b and two pairs of conveyance rollers 28 and connects between the conveyance mechanism 21 and the sheet-discharge portion 31.

In the space B, the sheet-supply unit 1b is disposed so as to be attachable to and detachable from the casing 1a. The sheet-supply unit 1b includes a sheet-supply tray 24 and a sheet-supply roller 25. The sheet-supply tray 24 has a box-like shape opening upward and accommodates a plurality of the sheets P of various sizes. The sheet-supply roller 25 supplies, to the upstream guide portion, an uppermost one of the sheets P accommodated in the sheet-supply tray 24.

As described above, in the spaces A, B is formed the sheet conveyance path extending from the sheet-supply unit 1b to the sheet-discharge portion 31 via the conveyance mechanism 21. The controller 1p, on the basis of the recording command received from the external device, drives a plurality of motors such as a sheet-supply motor 125 for the sheet-supply roller 25 (see FIG. 5), a conveyance motor 127 for the conveyance rollers of each guide portion (see FIG. 5), the conveyance motor 121 (see FIG. 5), and the like. The sheet P supplied from the sheet-supply tray 24 is fed or conveyed to the conveyance mechanism 21 by the conveyance rollers 26. In this conveyance, the controller 1p controls the power source 36 to adsorb, to the face 8a, the sheet P conveyed on the conveyance belt 8. When the sheet P passes through the positions just under the heads 10, the heads 10 eject the inks of the respective four colors in order, to form a color image on the sheet P. It is noted that the ink ejecting operation is performed on the basis of a detection signal outputted from a sheet sensor 20. The sheet P is then peeled by the peeling plate 5 and conveyed upward by the conveyance rollers 28. The sheet P is then discharged onto the sheet-discharge portion 31 through an opening 30.

In the space C, a cartridge unit 1c is disposed so as to be attachable to and detachable from the casing 1a. The cartridge unit 1c includes a tray 35 and the four cartridges 39 accommodated in the tray 35 so as to be arranged in a row. Each of the cartridges 39 stores the ink of the corresponding color. Each cartridge 39 supplies the ink to the corresponding head 10 via a tube, not shown.

There will be next explained the construction of the maintenance unit 61 (as one example of a cleaning mechanism) with reference to FIGS. 3, 4A, and 4B. As shown in FIG. 3, the maintenance unit 61 includes the wiper 41 (as one example of a first cleaning member) and a wiper cleaner 45. The wiper 41 is a plate-like member formed of an elastic material such as a rubber and extending in the main scanning direction. The wiper 41 is used for the first and second wiping operations which will be described below. The wiper 41 is disposed so as to be moved to come into contact with and come off the face 8a of the second area 16. A basal end (a lower end) of the wiper 41 is fixed to an outer circumferential face of a shaft 42. The shaft 42 extends in the main scanning direction and is supported by a frame 63 so as to be rotatable together with the wiper 41 about an axis extending in the main scanning direction. The frame 63 is fixed to the casing 1a (see FIG. 1).

As shown in FIG. 3, the maintenance unit 61 includes a gear 43a, a gear 43b, and a worm gear 43c as components for rotating the shaft 42. The gear 43a is fixed to an output shaft of a motor 41M, the gear 43b is meshed with the gear 43a, and the worm gear 43c is rotated with a rotation of the gear 43b. On one end of the shaft 42 is provided a worm wheel 42g which is meshed with an outer circumferential face of the worm gear 43c. A drive of the motor 41M rotates the gears 43a, 43 b, 43c, thereby rotating the worm wheel 42g. As a result, the shaft 42 is rotated about the axis extending in the main sunning direction, thereby changing an angle of inclination (an inclination angle) of the wiper 41 with respect to the horizontal plane.

The inclination angle of the wiper 41 is controlled by the controller 1p such that a distal end portion of the wiper 41 contacts the face 8a of the second area 16 of the conveyance belt 8 while bending in the first and second wiping operations and such that a distal end of the wiper 41 is distant from the face 8a at times other than the first and second wiping operations. That is, the maintenance unit 61 is configured such that the wiper 41 can selectively be in the contact state and the distant state with respect to the face 8a of the second area 16.

In the first wiping operation performed in the cleaning mode, the controller 1p controls the wiper 41 such that, as indicated by solid lines in FIG. 4B, the inclination angle of the wiper 41 (i.e., the angle of the wiper 41 with respect to the horizontal plane parallel to the face 8a) becomes an angle θ1. This state of the wiper 41 is a first pressing state in which a pressing force exerted on the face 8a of the second area 16 by the wiper 41 is a first pressing force. Here, the pressing force is a pressure per a unit area and expressed by the following equation.

Pressure per Unit Area=Q/S:

Q=a force applied to the area on the face 8a, which area is contacted by the wiper 41; and

S=an area (size) of the area on the face 8a, which area is contacted by the wiper 41

S=1*d:

l=a length of the conveyance belt 8 in the widthwise direction at the area on the face 8a, which area is contacted by the wiper 41 (i.e., a length of the conveyance belt 8 in the main scanning direction in the present embodiment); and

d=a length of the conveyance belt 8 in the sub-scanning direction at the area on the face 8a, which area is contacted by the wiper 41 (i.e., a length of a deformation part of the distal end of the wiper 41)

On the other hand, in the second wiping operation performed in the recording mode, the controller 1p controls the wiper 41 such that, as indicated by two-dot chain lines in FIG. 4B, the inclination angle of the wiper 41 becomes an obtuse angle θ2 greater than the angle θ1. This state of the wiper 41 is a second pressing state in which the pressing force acting on the face 8a of the second area 16 of the wiper 41 is a second pressing force that is smaller than the first pressing force. The second pressing force is set such that a frictional force between the wiper 41 and the face 8a of the second area 16 is smaller than that between the belt roller 7 and the conveyance belt 8 when the conveyance belt 8 is being rotated or run by the forward rotation of the belt roller 7.

As described above, the contact state in which the distal end of the wiper 41 is held in contact with the face 8a of the second area 16 includes the two pressing states different from each other and respectively corresponding to the first and second wiping operations, and the pressing force exerted on the face 8a of the second area 16 by the wiper 41 in the first pressing state (the first pressing force) is larger than the pressing force exerted on the face 8a of the second area 16 by the wiper 41 in the second pressing state (the second pressing force). Thus, a wiping performance (a cleaning performance) in the wiping for removing the foreign matters from the face 8a is higher in the first wiping operation than in the second wiping operation. However, even in the second wiping operation, the pressing force with respect to the face 8a is generated in some degree by the contact of the wiper 41 and the face 8a of the second area 16, making it possible to wipe the foreign matters such as the ink from the face 8a. Further, since the pressing force exerted on the face 8a of the second area 16 by the wiper 41 is smaller in the second wiping operation than in the first wiping operation, the frictional force between the wiper 41 and the face 8a in the second wiping operation is relatively small. Thus, even when the recording operation is being performed on the sheet P, the conveyance belt 8 becomes hard to slack, causing less slip of the conveyance belt 8 relative to the belt roller 7. This makes it possible to clean the face 8a of the conveyance belt 8 while keeping a good accuracy of the conveyance of the sheet P by the conveyance belt 8.

The inclination angle of the wiper 41 is controlled by the controller 1p such that the distal end of the wiper 41 is distant from the wiper cleaner 45 at times other than a wiper cleaning which will be described below.

Further, a length of the wiper 41 in the main scanning direction is slightly larger than the width of the conveyance belt 8 in the main scanning direction, and the wiper 41 is disposed so as to extend over an entire width of the conveyance belt 8. That is, the wiper 41 is disposed such that a center thereof in the main scanning direction coincides with a center of the conveyance belt 8 in a widthwise direction thereof and such that the wiper 41 projects from opposite ends of the conveyance belt 8 in the widthwise direction thereof in plan view. Thus, the distal end of the wiper 41 contacts the entire width of the conveyance belt 8 in the wiping operation.

The wiper cleaner 45 is used for the wiper cleaning and formed, e.g., by an absorber material such as a sponge. The wiper cleaner 45 has a cylindrical shape extending in the main scanning direction and is supported by a shaft 46 extending in the main scanning direction. The shaft 46 is supported by the frame 63 so as to be rotatable together with the wiper cleaner 45 about an axis extending in the main scanning direction.

The maintenance unit 61 includes a pulley 47, a pulley 46p, and a belt 48 as components for rotating the shaft 46. The pulley 47 is fixed to an output shaft of a motor 45M, the pulley 46p is fixed to one end of the shaft 46, and the belt 48 is wound around the pulley 46p and the pulley 47. When the pulley 47 is rotated with a drive of the motor 45M, the belt 48 is rotated or circulated, which rotates the pulley 46p. As a result, the shaft 46 is rotated together with the wiper cleaner 45 about the axis extending in the main scanning direction.

In the printer 1, a cleaning roller 12 (as one example of a second cleaning member) is provided such that the conveyance belt 8 is interposed between the cleaning roller 12 and the belt roller 6. A surface layer of the cleaning roller 12 is formed of, e.g., by an absorber material such as a sponge. The cleaning roller 12 is rotatable about an axis extending in the main scanning direction and is supported by a shaft of the belt roller 6 such that a center of the cleaning roller 12 and a center of the belt roller 6 always coincide with each other and such that a face 12a of the cleaning roller 12 is always held in contact with the face 8a of the conveyance belt 8. The cleaning roller 12 is rotated by the rotation or running of the conveyance belt 8.

Further, the cleaning roller 12 is disposed such that a pressing force exerted on the conveyance belt 8 is smaller than the second pressing force. That is, the cleaning roller 12 is disposed such that the face 12a is held in contact with the face 8a of the conveyance belt 8 so as to be hardly dented or bent. As a result, since the cleaning roller 12 is held in contact with the conveyance belt 8, the cleaning roller 12 can absorbs or removes the foreign matters such as the ink from the face 8a of the conveyance belt 8, that is, the cleaning roller 12 can clean the face 8a. Further, since the pressing force of the cleaning roller 12 on the conveyance belt 8 is small, a frictional force between the cleaning roller 12 and the conveyance belt 8 is relatively small. Thus, even when the recording operation is being performed on the sheet P, the conveyance belt 8 becomes hard to slack, causing less slip of the conveyance belt 8 relative to the belt roller 7. This makes it possible to clean the face 8a of the conveyance belt 8 while keeping a good accuracy of the conveyance of the sheet P by the conveyance belt 8 (that is, a quality of the image recorded by the heads 10 is kept). Further, since the cleaning roller 12 is rotated by the rotation or running of the conveyance belt 8, it is possible to suppress a running load of the conveyance belt 8 when compared with a case where a cleaning member that is not rotatable is used.

As a modification, the cleaning roller 12 may not be provided. Further, as another modification, instead of the cleaning roller 12, there may be provided a wiping member disposed such that a pressing force smaller than that of the wiper 41 being in the second pressing state is exerted on the conveyance belt 8. Also in this case, it is possible to clean the face 8a of the conveyance belt 8 while keeping a good accuracy of the conveyance of the sheet P by the conveyance belt 8. Further, as another modification, instead of the cleaning roller 12, there may be provided a wiping member disposed such that a pressing force smaller than that of the wiper 41 being in the first pressing state is exerted on the conveyance belt 8. This modification can also achieve the above-described effects. Further, as another modification, instead of the cleaning roller 12, there may be provided a non-contact remover capable of removing the foreign matters from the face 8a of the conveyance belt 8 in a state in which the non-contact remover does not contact the conveyance belt. As this non-contact remover, there may be employed an air suction means using an air suction force to remove the foreign matters from the face 8a of the conveyance belt 8 and an electrostatic adsorptive means using an electrostatic adsorptive force to remove the foreign matters from the face 8a of the conveyance belt 8, for example. This modification can also achieve the above-described effects. In addition, since the non-contact remover does not contact the conveyance belt 8, it is possible to remove the foreign matters from the face 8a of the conveyance belt 8 without generating any load on the rotation or running of the conveyance belt 8.

There will be next explained an electric configuration of the printer 1 with reference to FIG. 5. As shown in FIG. 5, the controller 1p includes a Central Processing Unit (CPU) 101, a Read Only Memory (ROM) 102, a Random Access Memory (RAM) 103 such as a nonvolatile RAM, an Application Specific Integrated Circuit (ASIC) 104, an interface (I/F) 105, an Input/Output Port (I/O) 106, and so on. The ROM 102 stores therein programs executed by the CPU 101, various fixed data, and so on. The RAM 103 temporarily stores therein data required for the execution of the programs, such as image data relating to an image to be formed on the sheet P. The ASIC 104 performs, e.g., rewriting and sorting of the image data. Specifically, the ASIC 104 performs a signal processing and an image processing, for example. The I/F 105 transmits or receives data to or from the external device. The I/O 106 inputs or outputs detection signals of various sensors. The controller 1p is connected to the motors 121, 125, 127, 41M, 45M, the sheet sensor 20, the power source 36, control boards for the respective heads 10, and so on.

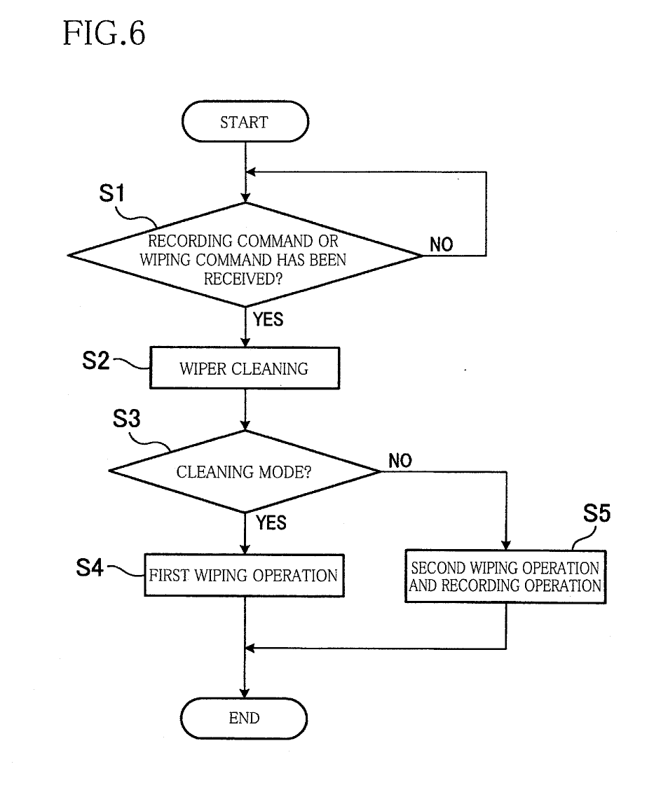

There will be next explained the control of the controller 1p with reference to FIG. 6. Processings explained below are executed by the CPU 101 in accordance with the programs stored in the ROM 102. As shown in FIG. 6, in S1, the controller 1p judges whether the recording command or the wiping command has been received or not. The wiping command is received when a sheet jamming occurs or after purging and/or preliminary ejection is performed on the face 8a of the first area 15, for example. The recording command is received when the recording operation is performed on the sheet P. It is noted that the mode of the printer 1 becomes the recording mode when the recording command has been received, and the mode of the printer 1 becomes the cleaning mode when the wiping command has been received.

Where the controller 1p has judged that the recording command or the wiping command has not been received (Si:NO), a standby state is continued. Where the controller 1p has judged that the recording command or the wiping command has been received (S1: YES), the controller 1p goes to S2.

In S2, the controller 1p drives the motor 41M in a state in which the conveyance belt 8 is stopped, to rotate the wiper 41 once in the clockwise direction in FIG. 1 about the axis extending in the main scanning direction. In this rotation, the distal end of the wiper 41 is brought into contact with the outer circumferential face of the wiper cleaner 45 while being deformed. In this operation, the foreign matters attached to the distal end of the wiper 41 are attached to the wiper cleaner 45, whereby the foreign matters are removed from the distal end of the wiper 41 (the wiper cleaning).

It is noted that, each time when one or several wiper cleanings (S2) are completed, the controller 1p rotates the wiper cleaner 45 by a predetermined angle smaller than 360 degrees. As a result, a portion of the wiper cleaner 45 which is contacted by the distal end of the wiper 41 in the wiper cleaning changes, thereby effectively removing the foreign matters attached to the distal end of the wiper 41.

Then in S3, the controller 1p judges whether the printer 1 is in the cleaning mode or not. Where the wiping command has been received in S1, the controller 1p goes to S4. Where the recording command has been received in S1, the controller 1p goes to S5.

In S4, the controller 1p drives the motor 41M to rotate the wiper 41 about the axis extending in the main scanning direction such that the inclination angle becomes θ1, whereby the distal end of the wiper 41 which is located at the position distant from the face 8a is brought into contact with the face 8a. The controller 1p stops the driving of the motor 41M at a timing when the distal end of the wiper 41 has been brought into contact with the face 8a while being deformed, and the controller 1p has the wiper 41 be in the first pressing state. The controller 1p then drives the conveyance motor 121 to rotate the belt roller 7 reversely to rotate or circulate the conveyance belt 8 once or several times.

As a result, the foreign matters on the face 8a of the conveyance belt 8 are removed by the wiper 41 while collected into the narrow area of the face 8a of the second area 16 (the first wiping operation). In this operation, the conveyance belt 8 is running in the direction opposite to a direction in which the conveyance belt 8 runs in the recording operation. That is, the second area 16 is located on a downstream side of the belt roller 6 (the tension roller) and located on an upstream side of the belt roller 7 (the drive roller) in the running direction of the conveyance belt 8 rotated by the reverse rotation of the belt roller 7. In other words, a certain portion of the conveyance belt 8 rotated by the belt roller 7 passes through the belt roller 6 to reach the second area 16. Here, since the conveyance belt 8 is given resistance by the friction between the conveyance belt 8 and the wiper 41 contacting the second area 16, slack is supposed to occur at a portion of the conveyance belt 8, which portion is located on a downstream side of the belt roller 7 and located on an upstream side of the wiper 41. However, in this embodiment, the belt roller 6 is disposed on a downstream side of the belt roller 7 and on an upstream side of the wiper 41, and the belt roller 6 applies the tension to the conveyance belt 8, making it difficult for the conveyance belt 8 to be slack. When it becomes difficult for the conveyance belt 8 to be slack, it becomes hard for the conveyance belt 8 and the belt roller 7 to be partly disengaged, whereby the drive power of the belt roller 7 is effectively transmitted to the conveyance belt 8. That is, a slip is less caused between the conveyance belt 8 and the belt roller 7.

The controller 1p stops the driving of the conveyance motor 121 after the conveyance belt 8 has been rotated or circulated once or several times. The controller 1p then drives the motor 41M in the state in which the conveyance belt 8 is stopped, whereby the wiper 41 is slightly rotated about the axis extending in the main scanning direction, so that the distal end of the wiper 41 comes off the face 8a. As a result, the first wiping operation is completed.

In S5, the controller 1p drives the motor 41M to rotate the wiper 41 about the axis extending in the main scanning direction such that the inclination angle becomes θ2, whereby the distal end of the wiper 41 which is located at the position distant from the face 8a of the second area 16 is brought into contact with the face 8a. The controller 1p stops the driving of the motor 41M at the timing when the distal end of the wiper 41 has been brought into contact with the face 8a while being deformed, and the controller 1p has the wiper 41 be in the second pressing state. The controller 1p then drives the conveyance motor 121 to rotate the belt roller 7 forwardly to run the conveyance belt 8 in the conveyance direction. As a result, the foreign matters on the face 8a of the conveyance belt 8 are removed by the wiper 41 while collected into the narrow area of the face 8a of the second area 16 (the second wiping operation). In this operation, in the running direction of the conveyance belt 8 rotated by the forward rotation of the belt roller 7, the second area 16 is located on a downstream side of the belt roller 7 (the drive roller) and located on an upstream side of the belt roller 6 (the tension roller). In other words, a certain portion of the conveyance belt 8 rotated by the belt roller 7 passes through the second area 16 to reach the belt roller 6. Here, since the conveyance belt 8 is given resistance by the friction between the conveyance belt 8 and the wiper 41 contacting the second area 16, slack is supposed to occur at a portion of the conveyance belt 8, which portion is located on a downstream side of the belt roller 7 and located on an upstream side of the wiper 41. However, in the second pressing state of the wiper 41, the pressing force (the second pressing force) of the wiper 41 on the second area 16 is set at the relatively small value, making it difficult for the conveyance belt 8 to be slack. Thus, even when the belt roller 7 is rotated forwardly, the conveyance belt 8 is hard to slack by the wiper 41, causing less slip of the conveyance belt 8 relative to the belt roller 7 as described above. It is noted that, in the present embodiment, the second wiping operation is performed without exception, but, as a modification, only the recording operation may be performed without performing the second wiping operation.

Further in S5, the controller 1p performs the recording operation. Specifically, the controller 1p controls the sheet-supply motor 125 and the conveyance motor 127 such that the sheet P is supplied from the sheet-supply tray 24 to the conveyance mechanism 21 and controls the power source 36 such that the sheet P is adsorbed or attracted to the face 8a of the first area 15. The controller 1p then outputs the ejection signals based on the image data to the heads 10 after a predetermined length of time has passed from a point in time when the controller 1p has received a detection signal for detecting a leading end of the sheet P from the sheet sensor 20 (that is, the controller 1p outputs the ejection signals when the sheet P passes through the positions just under the heads 10). As a result, the inks of the respective colors are ejected in order from the four heads to record the color image on the sheet P. In this operation, in the running direction of the conveyance belt 8 rotated by the forward rotation of the belt roller 7, the first area 15 is located on a downstream side of the belt roller 6 (the tension roller) and on an upstream side of the belt roller 7 (the drive roller). Since the first area 15 located on a downstream side of the belt roller 6 and located on an upstream side of the belt roller 7 is an area pulled or tensioned by the belt roller 7, the first area 15 is hard to slack, causing few vibrations due to the slack. Thus, it is possible to ensure the high image quality. Further, the conveyance belt 8 receives, at the first area 15, the adsorptive force generated by the adsorptive platen 22. Thus, slack is supposed to occur at a portion of the conveyance belt 8, which portion is located on a downstream side of the belt roller 7 and located on an upstream side of the adsorptive platen 22. However, in this embodiment, the belt roller 6 is disposed on a downstream side of the belt roller 7 and on an upstream side of the adsorptive platen 22, and the belt roller 6 applies the tension to the conveyance belt 8, making it difficult for the conveyance belt 8 to be slack. Thus, it is possible to ensure the high image quality.

Further, in the recording mode, the pressing force of the wiper 41 on the face 8a in the second wiping operation is relatively small, making it possible to clean the face 8a while keeping a good accuracy of the conveyance of the sheet P by the conveyance belt 8. Accordingly, it is possible to clean the conveyance belt 8 while keeping the quality of the image recorded by the heads 10. Thereafter, the sheet P on which the image has been recorded is peeled off from the conveyance belt 8 by the peeling plate 5 and conveyed upward by the two conveyance rollers 28 to be discharged from the opening 30 onto the sheet-discharge portion 31.

After the sheet P on which the image has been recorded has been discharged onto the sheet-discharge portion 31, the controller 1p stops the driving of the conveyance motor 121. The controller 1p then drives the motor 41M in the state in which the conveyance belt 8 is stopped, whereby the wiper 41 is slightly rotated about the axis extending in the main scanning direction, so that the distal end of the wiper 41 comes off the face 8a. As a result, the second wiping operation is completed. It is noted that, since the cleaning roller 12 is always held in contact with the conveyance belt 8, the cleaning roller 12 always cleans the face 8a of the conveyance belt 8.

As described above, when the printer 1 is in the recording mode, in the running direction of the conveyance belt 8, the first area 15 is located on a downstream side of the belt roller 6 (the tension roller) and located on an upstream side of the belt roller 7 (the drive roller), and the second area 16 is located on a downstream side of the belt roller 7 and located on an upstream side of the belt roller 6. Thus, it is possible to ensure the high image quality. Further, when the printer 1 is in the cleaning mode, the second area 16 is located on a downstream side of the belt roller 6 and located on an upstream side of the belt roller 7 in the running direction of the conveyance belt 8. Thus, a slip is less caused between the belt roller 7 and the conveyance belt 8, making it possible for the wiper 41 to clean the face 8a of the conveyance belt 8 with a relatively high cleaning performance in the cleaning mode.

Further, the belt roller 7 is rotated forwardly in the recording mode and rotated reversely in the cleaning mode. This simple control makes it possible to suppress the slip of the conveyance belt 8 relative to the belt roller 7 and makes it possible to clean the face 8a of the conveyance belt 8 with the wiper 41. Further, the plurality of the belt rollers 6, 7 included in the conveyance mechanism 21 are two rollers. This simple construction allows the wiper 41 to clean the face 8a of the conveyance belt 8 without the slip.

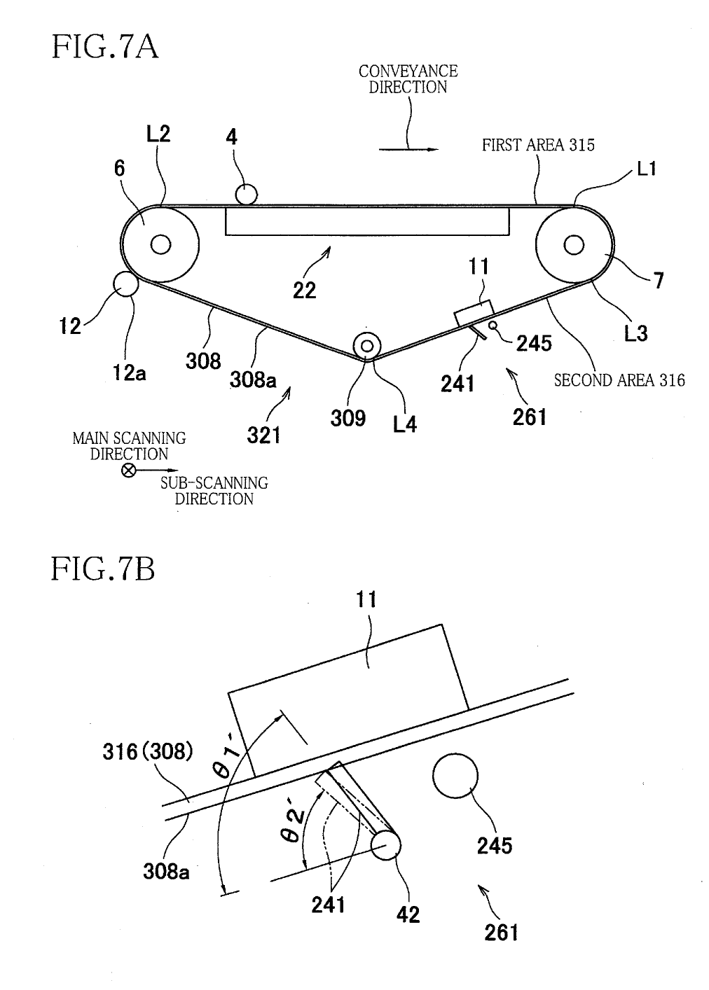

There will be next explained an ink-jet printer as the second embodiment of the present invention with reference to FIGS. 5, 7A, and 7B. In this ink-jet printer, a conveyance mechanism 321 includes: a roller 309 in addition to the two belt rollers 6, 7; and a conveyance motor 122 (indicated by broken lines in FIG. 5) and a plurality of gears, not shown, used for transmitting a rotational power of the conveyance motor 122 to the roller 309. Further, this ink-jet printer is different from that as the first embodiment in a construction of a maintenance unit 261 and a control for running of a conveyance belt 308 in the first wiping operation, but the other construction and controls in this second embodiment are the same as those in the first embodiment. It is noted that the same reference numerals as used in the first embodiment are used to designate the corresponding elements of this second embodiment, and an explanation of which is dispensed with.

As shown in FIGS. 7A and 7B, the roller 309 of the conveyance mechanism 321 is located at a center between the two belt rollers 6, 7 in the sub-scanning direction and located below these belt rollers 6, 7. An outside diameter of the roller 309 is smaller than that of each belt roller 6, 7, but a length of the roller 309 in the main scanning direction is the same as that of each belt roller 6, 7.

In the present embodiment, a first area 315 of the conveyance belt 308 is defined by the belt roller 6 and the belt roller 7. Further, a second area 316 of the conveyance belt 308 is defined by the belt roller 7 and the roller 309. The first area 315 is located between (i) a contact boundary L1 at which an upper portion of the belt roller 7 is held in contact with the conveyance belt 308 and (ii) a contact boundary L2 at which an upper portion of the belt roller 6 is held in contact with the conveyance belt 308. The second area 316 is an area different from the first area 315 and located between (i) a contact boundary L3 at which a lower portion of the belt roller 7 is held in contact with the conveyance belt 308 and a contact boundary L4 at which a portion of the roller 309 which is nearer to the belt roller 7 than to the belt roller 6 is held in contact with the conveyance belt 308. In other words, assuming that an area of the conveyance belt 308 which contacts any of the belt rollers 6, 7, 309 is a contact area, that an area of the conveyance belt 308 which does not contact any of the belt rollers 6, 7, 309 is a non-contact area, and that a boundary on the conveyance belt 308 between the contact area and the non-contact area is a contact boundary (in the present embodiment, each of the contact boundaries L1, L2, L3, and L4 corresponds to the contact boundary), the first area 315 is an area on the conveyance belt 308 which is located between the contact boundaries L2, L1 of the respective belt rollers 6, 7, and the second area 316 is a non-contact area on the conveyance belt 308 which is located between the respective contact boundaries L3, L4 of the belt roller 7 and the roller 309 and which does not include any contact area.

The belt roller 7 is rotated by the conveyance motor 121 that is controlled by the controller 1p. In the recording mode, the controller 1p controls the belt roller 7 to be rotated forwardly (in a clockwise direction in FIG. 7). This forward rotation of the belt roller 7 causes the conveyance belt 308 to rotate or run such that a part of the conveyance belt 308 at the first area 315 moves in the conveyance direction. It is noted that the belt roller 6 is a tension roller rotated by the rotation or running of the conveyance belt 308 while applying a tension to the conveyance belt 308.

The roller 309 is rotated by the conveyance motor 122 that is controlled by the controller 1p. In the cleaning mode, the controller 1p controls the roller 309 to be rotated forwardly (in the clockwise direction in FIG. 7). This forward rotation of the roller 309 causes the conveyance belt 308 to rotate or run such that the part of the conveyance belt 308 at the first area 315 moves in the conveyance direction.

In the present embodiment, the conveyance mechanism 321 includes the two drive rollers, and a drive roller used for running the conveyance belt 308 is different between the recording mode and the cleaning mode. That is, the belt roller 7 is driven in the recording mode, and the roller 309 is driven in the cleaning mode. Also in the present embodiment, when the printer 1 is in the recording mode, in the running direction of the conveyance belt 308, the first area 315 is located on a downstream side of the belt roller 6 (the tension roller) and located on an upstream side of the belt roller 7 (the drive roller), and the second area 316 is located on a downstream side of the belt roller 7 and located on an upstream side of the belt roller 6. On the other hand, when the printer 1 is in the cleaning mode, the second area 316 is located on a downstream side of the belt roller 6 and located on an upstream side of the roller 309 (the drive roller) in the running direction of the conveyance belt 308.

As shown in FIG. 7, an arrangement of a wiper 241 and a wiper cleaner 245 of the maintenance unit 261 is reverse in the sub-scanning direction to that of the wiper 41 and the wiper cleaner 45 of the maintenance unit 61 of the first embodiment. The controller 1p controls the belt roller 7 and the roller 309 to be driven such that the part of the conveyance belt 308 at the first area 315 is moved in the conveyance direction in any of the first and second wiping operations. Thus, the maintenance unit 261 is controlled by the controller 1p such that the wiper 241 contacts a face 308a of the second area 316 in a state in which the wiper 241 is inclined in the same direction in any of the first and second wiping operations (i.e., the state shown in FIGS. 7A and 7B). As shown in FIG. 7B, an inclination angle θ1′ of the wiper 241 in the first wiping operation is greater than an inclination angle θ2′ of the wiper 241 in the second wiping operation. That is, a pressing force exerted on the face 308a by the wiper 241 in the first wiping operation (a first pressing force) is larger than a pressing force exerted on the face 308a by the wiper 241 in the second wiping operation (a second pressing force). As a result, this second embodiment can achieve the effects in the first embodiment. It is noted that, like the first embodiment, the maintenance unit 261 is disposed at a position at which the wiper 241 can be moved so as to come into contact with or come off the face 308a of the second area 16, and the maintenance unit 261 has generally the same construction as that of the maintenance unit 61 in the first embodiment.

There will be next explained a control of the controller 1p in this second embodiment. In this embodiment, processings S1-S5 generally the same as those in the first embodiment are executed.

In 54, the controller 1p drives the motor 41M to rotate the wiper 241 about an axis extending in the main scanning direction such that the inclination angle becomes θ1′, whereby a distal end of the wiper 241 is brought into contact with the face 308a. The controller 1p stops the driving of the motor 41M at a timing when the distal end of the wiper 241 has been brought into contact with the face 308a while being deformed, and has the wiper 241 be in the first pressing state. The controller 1p then drives the conveyance motor 122 in a state in which the driving of the conveyance motor 121 is stopped, so as to rotate the roller 309 forwardly. The controller 1p rotates or circulates the conveyance belt 308 once or several times. In this operation, the belt roller 7 is rotated forwardly as a driven roller by the rotation or running of the conveyance belt 308. As a result, the foreign matters on the face 308a of the conveyance belt 308 are removed by the wiper 241 while collected into the narrow area of the face 308a of the second area 316 (the first wiping operation). In this operation, in the running direction of the conveyance belt 308, the second area 316 is located on a downstream side of the belt roller 6 (the tension roller) and located on an upstream side of the roller 309 (the drive roller). Thus, even when the conveyance belt 308 is given resistance by a friction between the conveyance belt 308 and the wiper 241 contacting the second area 316, and slack is supposed to occur at the conveyance belt 308, the belt roller 6 applies the tension to the conveyance belt 308, making it difficult for the conveyance belt 308 to be slack. When it becomes difficult for the conveyance belt 308 to be slack, it becomes hard for the conveyance belt 308 and the roller 309 to be partly disengaged, whereby the drive power of the roller 309 is effectively transmitted to the conveyance belt 308. That is, a slip is less caused between the conveyance belt 308 and the roller 309.

The controller 1p stops the driving of the conveyance motor 122 after the conveyance belt 308 has been rotated or circulated once or several times. The controller 1p then drives the motor 41M in a state in which the conveyance belt 308 is stopped, whereby the wiper 241 is slightly rotated about the axis extending in the main scanning direction, so that the distal end of the wiper 241 comes off the face 308a. As a result, the first wiping operation is completed.

In S5, the controller 1p drives the motor 41M to rotate the wiper 241 about the axis extending in the main scanning direction such that the inclination angle becomes θ2′, whereby the distal end of the wiper 241 is brought into contact with the face 308a. The controller 1p stops the driving of the motor 41M at the timing when the distal end of the wiper 241 has been brought into contact with the face 308a while being deformed, and has the wiper 241 be in the second pressing state. The controller 1p then drives the conveyance motor 121 in a state in which the driving of the conveyance motor 122 is stopped, so as to rotate the belt roller 7 forwardly, whereby the conveyance belt 308 runs in the conveyance direction. In this operation, the roller 309 is rotated forwardly as a driven roller by the rotation or running of the conveyance belt 308. As a result, the foreign matters on the face 308a of the conveyance belt 308 are removed by the wiper 241 while collected into the narrow area of the face 308a of the second area 316 (the second wiping operation). In this operation, since the pressing force of the wiper 241 on the face 308a is relatively small, it is possible to clean the face 308a while keeping a good accuracy of the conveyance of the sheet P by the conveyance belt 308 as in the first embodiment.

As in the first embodiment, the controller 1p performs the recording operation in S5. Specifically, the controller 1p controls the sheet-supply motor 125 and the conveyance motor 127 such that the sheet P is supplied from the sheet-supply tray 24 to the conveyance mechanism 21 and controls the power source 36 such that the sheet P is adsorbed or attracted to the face 308a of the first area 315. The controller 1p then outputs ejection signals based on the image data to the heads 10 and controls the heads 10 to eject the inks of the respective colors to record the color image on the sheet P. In this operation, in the running direction of the conveyance belt 308, the first area 315 is located on a downstream side of the belt roller 6 (the tension roller) and on an upstream side of the belt roller 7 (the drive roller). Since the first area 315 located on a downstream side of the belt roller 6 and located on an upstream side of the belt roller 7 is an area pulled or tensioned by the belt roller 7, the first area 315 is hard to slack, causing few vibrations due to the slack. Thus, it is possible to ensure the high image quality. Further, the conveyance belt 308 receives, at the first area 315, the adsorptive force generated by the adsorptive platen 22. Thus, slack is supposed to occur at a portion of the conveyance belt 308, which portion is located on a downstream side of the belt roller 7 and located on an upstream side of the adsorptive platen 22. However, in this embodiment, the belt roller 6 is disposed on a downstream side of the belt roller 7 and on an upstream side of the adsorptive platen 22, and the belt roller 6 applies the tension to the conveyance belt 308, making it difficult for the conveyance belt 308 to be slack. Thus, it is possible to ensure the high image quality. Thereafter, the sheet P on which the image has been recorded is peeled off from the face 308a by the peeling plate 5 and conveyed upward by the two conveyance rollers 28 to be discharged from the opening 30 onto the sheet-discharge portion 31.

After the sheet P on which the image has been recorded has been discharged onto the sheet-discharge portion 31, the controller 1p stops the driving of the conveyance motor 121. The controller 1p then drives the motor 41M in the state in which the conveyance belt 308 is stopped, whereby the wiper 241 is slightly rotated about the axis extending in the main scanning direction, so that the distal end of the wiper 241 comes off the face 308a. As a result, the second wiping operation is completed. It is noted that, since the cleaning roller 12 is always held in contact with the conveyance belt 308, the cleaning roller 12 always cleans the face 308a.

As described above, the printer as the present embodiment includes the two conveyance motors 121, 122 capable of respectively applying the rotational powers to the belt roller 7 and the roller 309. The roller 309 is rotated forwardly in the cleaning mode, and the belt roller 7 is rotated forwardly in the recording mode. Accordingly, it is possible to achieve effects the same as those in the first embodiment.

As a modification of the present embodiment, the plurality of gears for transmitting the rotational powers from the conveyance motor 122 and the conveyance motor 122 to the roller 309 may be omitted. In this case, the belt roller 7 is configured to be rotatable forwardly and reversely like the first embodiment. The controller 1p rotates the belt roller 7 forwardly in the recording mode and rotates the belt roller 7 reversely in the cleaning mode. Also in this construction, when the printer is in the recording mode, the first area 315 is located on a downstream side of the belt roller 6 (the tension roller) and located on an upstream side of the belt roller 7 (the drive roller) in the running direction of the conveyance belt 308. Further, when the printer is in the cleaning mode, the second area 316 is located on a downstream side of the belt roller 6 and located on an upstream side of the belt roller 7 in the running direction of the conveyance belt 308. Further, in the case where the belt roller 7 is configured to be rotatable forwardly and reversely, an urging mechanism for applying a tension to the conveyance belt 308 via the roller 309 may be provided without providing the urging mechanism for applying the tension to the conveyance belt 308.

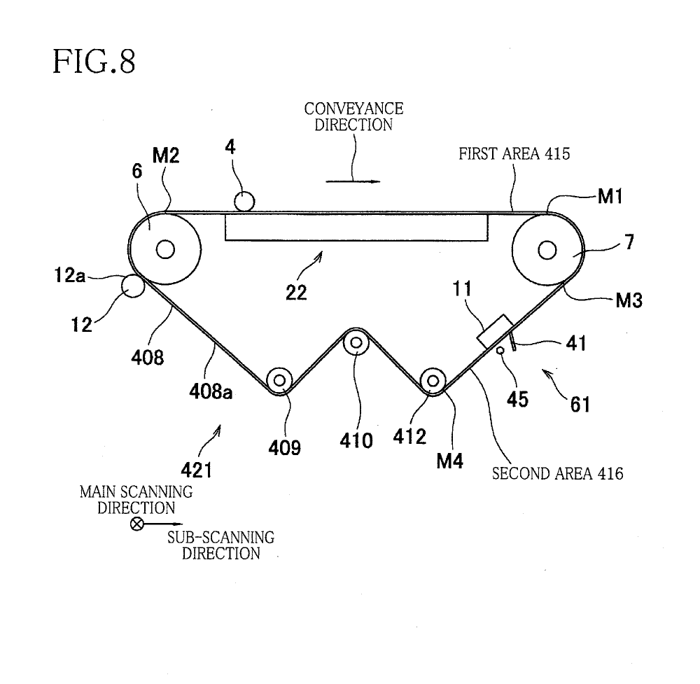

There will be next explained an ink-jet printer as the third embodiment of the present invention with reference to FIG. 8. In the ink-jet printer as the present embodiment, a conveyance mechanism 421 includes rollers 409, 410, 412 in addition to the two belt rollers 6, 7, and the other construction in this third embodiment is the same as that in the first embodiment. It is noted that the same reference numerals as used in the first embodiment are used to designate the corresponding elements of this third embodiment, and an explanation of which is dispensed with.

As shown in FIG. 8, the rollers 409, 410, 412 of the conveyance mechanism 421 are located below the belt rollers 6, 7. An outside diameter of each of the rollers 409, 410, 412 is smaller than that of each belt roller 6, 7, but a length of each of the rollers 409, 410, 412 in the main scanning direction is the same as that of each belt roller 6, 7. The roller 410 is disposed so as to be held in contact with a face 408a. The rollers 409, 412 are tension rollers and urged downward in the vertical direction by an urging mechanism, not shown. Thus, tensions are applied to a conveyance belt 408. In the present embodiment, the urging mechanism for urging the belt roller 6 is not provided. That is, in the present embodiment, the belt roller 6 is not a tension roller.

In the present embodiment, a first area 415 of the conveyance belt 408 is defined by the belt roller 6 and the belt roller 7. A second area 416 of the conveyance belt 408 is defined by the belt roller 7 and the roller 412. The first area 415 is located between (i) a contact boundary M1 at which the upper portion of the belt roller 7 is held in contact with the conveyance belt 408 and (ii) a contact boundary M2 at which the upper portion of the belt roller 6 is held in contact with the conveyance belt 408. The second area 416 is an area different from the first area 415 and located between (i) a contact boundary M3 at which the lower portion of the belt roller 7 is held in contact with the conveyance belt 408 and (ii) a contact boundary M4 at which a portion of the roller 412 which is nearer to the belt roller 7 than to the belt roller 6 is held in contact with the conveyance belt 408. In other words, assuming that an area of the conveyance belt 408 which contacts any of the belt rollers 6, 7, 409-412 is a contact area, that an area of the conveyance belt 408 which does not contact any of the belt rollers 6, 7, 409-412 is a non-contact area, and that a boundary on the conveyance belt 408 between the contact area and the non-contact area is a contact boundary (in the present embodiment, each of the contact boundaries M1, M2, M3, and M4 corresponds to the contact boundary), the first area 415 is an area on the conveyance belt 408 which is located between the contact boundaries M2, M1 of the respective belt rollers 6, 7, and the second area 416 is a non-contact area on the conveyance belt 408 which is located between the respective contact boundaries M3, M4 of the belt roller 7 and the roller 412 and which does not include any contact area.

In the present embodiment, when the belt roller 7 has been rotated forwardly (in a clockwise direction in FIG. 8), in a running direction of the conveyance belt 408, a part of the conveyance belt 408 at the first area 415 is moved to a position located on a downstream side of the roller 409 or the roller 412 (the tension roller) and located on an upstream side of the belt roller 7 (the drive roller), and the part of the conveyance belt 408 at the second area 416 is moved to a position located on a downstream side of the belt roller 7 (the drive roller) and located on an upstream side of the roller 409 or the roller 412 (the tension roller). On the other hand, when the belt roller 7 has been rotated reversely, the part of the conveyance belt 408 at the second area 416 is moved to a position located on a downstream side of the roller 409 or the roller 412 (the tension roller) and located on an upstream side of the belt roller 7 (the drive roller).

The maintenance unit 61 is disposed at a position opposed to the second area 416 of the conveyance belt 408. The wiper 41 is disposed so as to be movable to come into contact with or come off the face 408a of the second area 416.

In this embodiment, processings S1-S5 generally the same as those in the first embodiment are executed. In S4, the controller 1p controls the motor 41M to have the wiper 41 be in the first pressing state. The controller 1p then drives the conveyance motor 121 to rotate the belt roller 7 reversely to rotate or circulate the conveyance belt 8 once or several times.

As in the first embodiment, the first wiping operation is performed. As thus described, the belt roller 7 is rotated reversely when the face 408a of the conveyance belt 408 is wiped, whereby the second area 416 is located on a downstream side of the roller 409 or the roller 412 (the tension roller) and located on an upstream side of the belt roller 7 (the drive roller) in the running direction of the conveyance belt 408, making it possible to achieve effects the same as those in the first embodiment. More specifically, a certain portion of the conveyance belt 408 rotated by the belt roller 7 passes through the roller 409 and the roller 412 to reach the second area 416. Here, since the conveyance belt 408 is given resistance by a friction between the conveyance belt 408 and the wiper 41 contacting the second area 416, slack is supposed to occur at a portion of the conveyance belt 408, which portion is located on a downstream side of the belt roller 7 and located on an upstream side of the wiper 41. However, in this embodiment, the roller 409 and the roller 412 are disposed on a downstream side of the belt roller 7 and on an upstream side of the wiper 41, and the roller 409 and the roller 412 apply the tensions to the conveyance belt 408, making it difficult for the conveyance belt 408 to be slack. Accordingly, a slip is less caused between the conveyance belt 408 and the belt roller 7. It is noted that, also in a case where a plurality of the tension rollers (the rollers 409, 410) are provided as in the present embodiment, the slip of the conveyance belt 408 can be prevented as long as the second area 416 is located on a downstream side of any one of the tension rollers (the roller 409 or the roller 410) and is located on an upstream side of the drive roller (the belt roller 7) in the running direction of the conveyance belt 408.

After the controller 1p has rotated the conveyance belt 408 once or several times, the controller 1p stops the driving of the conveyance motor 121. The controller 1p then drives the motor 41M such that the distal end of the wiper 41 comes off the face 408a. As a result, the first wiping operation is completed.

In S5, the controller 1p controls the motor 41M to have the wiper 41 be in the second pressing state. The controller 1p then drives the conveyance motor 121 to rotate the belt roller 7 forwardly to run the conveyance belt 408 in the conveyance direction. In this operation, a pressing force of the wiper 41 on the face 408a is relatively small, making it possible to clean the face 408a while keeping a good accuracy of the conveyance of the sheet P by the conveyance belt 408.

As in the first embodiment, the controller 1p performs the recording operation. Specifically, the controller 1p controls the sheet-supply motor 125 and the conveyance motor 127 such that the sheet P is supplied from the sheet-supply tray 24 to the conveyance mechanism 21 and controls the power source 36 such that the sheet P is adsorbed or attracted to the face 408a of the first area 415. The controller 1p then outputs ejection signals based on the image data to the heads 10 and controls the heads 10 to eject the inks of the respective colors to record the color image on the sheet P. In this operation, in the running direction of the conveyance belt 408, the first area 415 is located on a downstream side of the roller 409 or the roller 412 (the tension roller) and on an upstream side of the belt roller 7 (the drive roller). Since the first area 415 located on a downstream side of the roller 409 or the roller 412 and located on an upstream side of the belt roller 7 is an area pulled or tensioned by the belt roller 7, the first area 415 is hard to slack, causing few vibrations due to the slack. Thus, it is possible to ensure the high image quality. Further, the conveyance belt 408 receives, at the first area 415, the adsorptive force generated by the adsorptive platen 22. Thus, slack is supposed to occur at the portion of the conveyance belt 408, which portion is located on a downstream side of the belt roller 7 and located on an upstream side of the adsorptive platen 22. However, in this embodiment, the roller 409 and the roller 412 are disposed on a downstream side of the belt roller 7 and on an upstream side of the adsorptive platen 22, and the roller 409 and the roller 412 apply the tensions to the conveyance belt 408, making it difficult for the conveyance belt 408 to be slack. Thus, it is possible to ensure the high image quality. Thereafter, the sheet P on which the image has been recorded is peeled off from the conveyance belt 408 by the peeling plate 5 and conveyed upward by the two conveyance rollers 28 to be discharged from the opening 30 onto the sheet-discharge portion 31.

After the sheet P on which the image has been recorded has been discharged onto the sheet-discharge portion 31, the controller 1p stops the driving of the conveyance motor 121. The controller 1p then drives the motor 41M in the state in which the conveyance belt 408 is stopped, whereby the wiper 41 is slightly rotated about the axis extending in the main scanning direction, so that the distal end of the wiper 41 comes off the face 408a. As a result, the second wiping operation is completed. It is noted that, since the cleaning roller 12 is always held in contact with the conveyance belt 408, the cleaning roller 12 always cleans the face 408a.

As described above, in the printer as the present embodiment, the belt roller 7 is rotated reversely in the cleaning mode and rotated forwardly in the recording mode, making it possible to achieve effects the same as those in the first embodiment.

As a modification of the printer as the third embodiment, the conveyance mechanism 421 may include an urging mechanism for applying a tension to the conveyance belt 408 via the belt roller 6 as in the first embodiment. Further, this printer may omit the urging mechanism for applying the tension to the conveyance belt 408 via the roller 409 or the roller 412 and include a motor for rotating the roller 409 or the roller 412 and a plurality of gears, not shown, used for transmitting a rotational power of the motor to the roller 409 or the roller 412. In this case, the controller 1p rotates the belt roller 7 forwardly in the recording mode and rotates the roller 409 or the roller 412 forwardly in the cleaning mode. Where the roller 412 is the drive roller, the second area 416 is located between the contact boundary M3 and the contact boundary M4. Where the roller 409 is the drive roller, the second area 416 may be located between the contact boundary M3 and the contact boundary M4 and may be located between (i) a contact boundary at which a portion of the roller 412 nearer to the roller 410 than to the belt roller 7 is held in contact with the conveyance belt 408 and (ii) a contact boundary at which a portion of the roller 410 nearer to the roller 412 than to the roller 409 is held in contact with the conveyance belt 408. Further, the second area 416 may be located between (i) a contact boundary at which a portion of the roller 410 near to the roller 409 than to the roller 412 is held in contact with the conveyance belt 408 and a contact boundary at which a portion of the roller 409 nearer to the roller 410 than to the belt roller 6 is held in contact with the conveyance belt 408.

While the embodiments of the present invention has been described above, it is to be understood that the invention is not limited to the details of the illustrated embodiments, but may be embodied with various changes and modifications, which may occur to those skilled in the art, without departing from the spirit and scope of the invention. For example, the conveyance mechanism includes the two conveyance motors 121, 122 and so on in the above-described second embodiment but may include one conveyance motor and a power transmitting mechanism configured to transmit a rotational power of the conveyance motor selectively to the belt rollers 6, 7. In this case, the number of the motors can be reduced, leading to a lower manufacturing cost. Further, in the above-described first, second, and third embodiments and their respective modifications, the second wiping operation may be omitted. That is, the wiping operation may not be performed during the recording operation. In this case, the first cleaning member may not take the second pressing state. Further, in the above-described embodiments, each of the wipers 41, 241 is moved by the rotation of the shaft 42 between the position at which the wiper is held in contact with the face of the second area of the conveyance belt and the position at which the wiper is distant from the face of the second area of the conveyance belt, but each of the wipers 41, 241 may be moved between the contact position and the distant position by a moving mechanism such as a solenoid, for example. Further, each of the wipers 41, 241 may extend in a direction intersecting the main scanning direction and the sub-scanning direction. Further, the conveyance mechanism may include equal to or more than five rollers. Further, the construction of the conveyance mechanism and the positions of the recording head and the maintenance unit 61 are not limited to those in the above-described embodiments and may be any construction and positions as long as the first area is located on a downstream side of the tension roller and located on an upstream side of the drive roller in the running direction of the conveyance belt in the recording mode, and the second area is located on a downstream side of the tension roller and located on an upstream side of the drive roller in the running direction of the conveyance belt in the cleaning mode. It is noted that, in the above-described embodiments, the printer 1 is configured such that the recording operation of the heads 10 is not performed in the cleaning mode, but may be configured such that the recording operation of the heads 10 is performed in the cleaning mode. That is, the recording operation may be performed in the cleaning mode as long as no disadvantageous effects are caused on the recording quality of the recording operation of the heads 10.

The present invention is applicable to any of a line printer and a serial printer. Further, the application of the present invention is not limited to the printer, and the present invention is applicable to a facsimile machine, a copying machine, and the like and applicable to a recording apparatus configured to perform recording by ejecting liquid other than the ink. Further, the application of the present invention is not limited to the ink-jet recording apparatus, and the present invention is applicable to a laser or thermal recording apparatus, for example. The recording medium is not limited to the sheet P, and various recording media may be used.

What is claimed is:

1. A recording apparatus, comprising:
a conveyance mechanism including an endless belt looped over a plurality of rollers that are arranged so as to be distant from one another and that include at least one tension roller and at least one drive roller, the endless belt having a face including (i) a first area defined by two rollers of the plurality of rollers and (ii) a second area defined by two rollers of the plurality of rollers and not overlapping with the first area, the conveyance mechanism being configured to convey a recording medium supported on the first area;
a recording head opposed to the first area and configured to eject liquid onto the recording medium supported on the first area to record an image;
a cleaning mechanism including a first cleaning member contactable with the second area to selectively take a contact state in which the first cleaning member is held in contact with the second area and a distant state in which the first cleaning member is distant from the second area; and
a controller configured to control the conveyance mechanism and the cleaning mechanism,
wherein, in a recording mode in which the recording head records the image, the controller is configured to drive at least one of the at least one drive roller such that the first area is located on a downstream side of the at least one tension roller and located on an upstream side of the at least one of the at least one drive roller in a running direction of the belt and such that the second area is located on a downstream side of the at least one of the at least one drive roller and located on an upstream side of the at least one tension roller in the running direction of the belt, and
wherein, in a cleaning mode which does not overlap with the recording mode timewise and in which the first cleaning member cleans the belt, the controller is configured to have the first cleaning member be in the contact state and to drive at least one of the at least one drive roller such that the second area is located on a downstream side of the at least one tension roller and located on an upstream side of the at least one of the at least one drive roller in the running direction of the belt.

2. The recording apparatus according to claim 1, wherein the image recording by the recording head is not performed in the cleaning mode.

3. The recording apparatus according to claim 1,
wherein the belt has a face held in contact with the plurality of rollers, the face including:
a contact area that is an area contacting at least one of the plurality of rollers;
a non-contact area that is an area not contacting any of the plurality of rollers; and
a plurality of contact boundaries each of which is an boundary between the contact area and the non-contact area, and
wherein the first area is at least a portion of the non-contact area that is located on the belt between the plurality of contact boundaries of the respective two rollers defining the first area and that does not include the contact area.

4. The recording apparatus according to claim 1,
wherein the belt has a face held in contact with the plurality of rollers, the face including:
a contact area that is an area contacting at least one of the plurality of rollers;
a non-contact area that is an area not contacting any of the plurality of rollers; and
a plurality of contact boundaries each of which is an boundary between the contact area and the non-contact area, and
wherein the second area is at least a portion of the non-contact area that is located on the belt between the plurality of contact boundaries of the respective two rollers defining the second area and that does not include the contact area.

5. The recording apparatus according to claim 1,
wherein the plurality of rollers include one drive roller as the at least one drive roller, and
wherein the controller is configured to rotate the one drive roller in one direction in the recording mode and rotate the one drive roller in a direction opposite to the one direction in the cleaning mode.

6. The recording apparatus according to claim 5, wherein the plurality of rollers are constituted by one drive roller and one tension roller.

7. The recording apparatus according to claim 1,
wherein the plurality of rollers include two drive rollers as the at least one drive roller, and
wherein the controller is configured to drive one of the two drive rollers in the recording mode and drive the other of the two drive rollers in the cleaning mode.

8. The recording apparatus according to claim 7, wherein the two drive rollers are rotated in the same direction in the recording mode and in the cleaning mode.

9. The recording apparatus according to claim 1,
wherein the contact state includes (i) a first pressing state in which a pressing force of the first cleaning member on the second area is a first pressing force and (ii) a second pressing state in which the pressing force of the first cleaning member on the second area is a second pressing force that is smaller than the first pressing force,
wherein, in the cleaning mode, the controller is configured to control the cleaning mechanism such that the first cleaning member takes the first pressing state, and
wherein, in the recording mode, the controller is configured to control the cleaning mechanism such that the first cleaning member cleans the belt while the recording head performs the image recording and such that the first cleaning member takes the second pressing state.

10. The recording apparatus according to claim 1, further comprising a second cleaning member configured to clean the belt in the recording mode with a pressing force that is smaller than a pressing force of the first cleaning member being in the contact state on the second area.
